(19) United States
(12) Patent Application Publication
(10) Pub. No.: US 2017/0164050 A1
(43) Pub. Date: Jun. 8, 2017

(54) PRESENTING ALTERNATE CONTENT

(71) Applicant: Cisco Technology, Inc., San Jose, CA (US)

(72) Inventors: Pete RAI, Egham (GB); Trevor SMITH, Twickenham (GB); Stephen-John CRAIG, Maidenhead (GB); Alexander KIRKPATRICK, London (GB)

(21) Appl. No.: 14/960,384

(22) Filed: Dec. 6, 2015

(51) Int. Cl. H04N 21/44; H04N 21/858; H04N 21/64; H04N 21/472; H04N 21/482; H04N 21/81; H04N 21/438

(52) U.S. Cl. CPC H04N 21/44016; H04N 21/812; H04N 21/8586; H04N 21/4383; H04N 21/472; H04N 21/482; H04N 21/64

(57) ABSTRACT

In one embodiment, a method for presenting alternate content during a channel change on a video content playing device includes: receiving a viewer's request to tune to a particular channel, retrieving tuning context data from a memory of the video content playing device, where the tuning context data is indicative of a context in which the viewer tunes to the particular channel, processing the tuning context data using a channel function associated with the particular channel to identify alternate content likely to be of interest to a viewer of the particular channel, identifying a network address for the alternate content associated with the particular channel in accordance with a result of the processing, retrieving the alternate content according to the network address, and presenting the alternate content on the video content playing device before presenting the program currently being broadcast on the particular channel.

### FIELD OF THE INVENTION

The present invention generally relates to the presentation of alternate content within linear television during channel change.

### BACKGROUND OF THE INVENTION

Attracting and retaining viewers has become a key business challenge for television (TV) channel operators as this normally has a direct impact on their revenues. As a result, TV channel operators are increasingly employing strategies/techniques to stop viewers from tuning away between two shows. Examples of such techniques include: “squeezing back” the program credits to present a trailer for the next show; presenting customized advertisements during a commercial break; etc.

### BRIEF DESCRIPTION OF THE DRAWINGS

The present invention will be understood and appreciated more fully from the following detailed description, taken in conjunction with the drawings in which:

FIG. 1 is a simplified pictorial illustration of an exemplary channel zapping mechanism, constructed and operative in accordance with an embodiment of the present invention;

FIG. 2 is a schematic illustration of an exemplary video content playing device operative to identify and present the alternate content of FIG. 1, constructed and operative in accordance with an embodiment of the present invention;

FIG. 3 is a partly pictorial partly schematic illustration of elements of the video content playing device of FIG. 2 operative to present alternate content when a viewer zaps on a particular channel, constructed and operative in accordance with an embodiment of the present invention; and

FIG. 4 is a block diagram illustration of a method for identifying and presenting the alternate content of FIG. 1 in accordance with some embodiments of the present invention.

### DESCRIPTION OF EXAMPLE EMBODIMENTS

### Overview

A method for presenting alternate content during a channel change on a video content playing device includes: receiving a viewer's request to tune to a particular channel, retrieving tuning context data from a memory of the video content playing device, where the tuning context data is indicative of a context in which the viewer tunes to the particular channel, processing the tuning context data using a channel function associated with the particular channel to identify alternate content likely to be of interest to a viewer of the particular channel, identifying a network address for the alternate content associated with the particular channel in accordance with a result of the processing, retrieving the alternate content according to the network address, and presenting the alternate content on the video content playing device before presenting the program currently being broadcast on the particular channel.

### Description

Linear TV is still the mainstay of the television experience and presents content to viewers in a pre-agreed, ordered sequence, aligned to time/schedule fashion. This schedule is typically the same for all viewers as linear TV is normally broadcast in a one-to-many model.

Linear TV viewers often engage in “channel hopping” navigation techniques allowing them to “taste” content on a variety of different channels quickly. Given that viewers may join a channel at any time, it is not likely that their encounter with a channel will neatly align to program boundaries within its schedule. For example, viewers may join shows that have already begun or are close to their end or they may join a channel whilst it is showing non-program interstitial content such as adverts, promos, trailers, station idents, etc.

The viewers' rendezvous with a channel may be driven by a specific intent (e.g. they have tuned-in to watch a specific program) or may be unintentional (e.g. they have tuned-in because they are channel surfing). In both situations, it is possible that the content currently being broadcast on the channel is not in harmony with the intent, interests or mood of the viewer at that time. As it stands, there is no mechanism for the channel to assess these axes and/or to modify the channel content to be more line with them.

The inventors of the present invention have realized that, in many cases, it may be preferential for the channel to show individual viewers alternate content, for a given time period, in order to minimize the risk of them tuning away and also to maximize their engagement with the channel and its content.

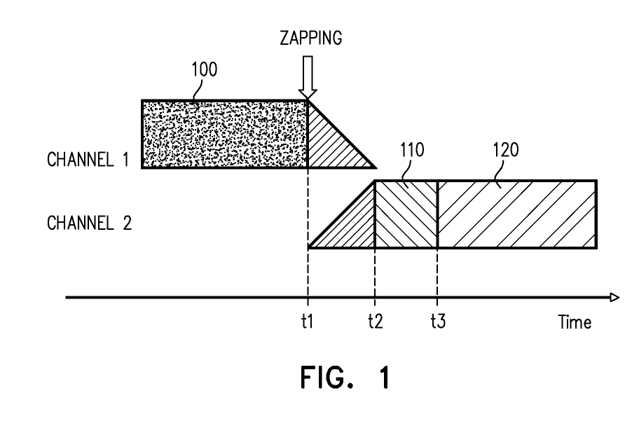

Reference is now made to FIG. 1 which is an illustration of an exemplary channel zapping mechanism, constructed and operative in accordance with an embodiment of the present invention.

FIG. 1 illustrates an exemplary zapping sequence between channel 1 and channel 2. Typically, a viewer of a video content playing device is watching a first program 100 currently being broadcast on channel 1 and then, decides, at t1, to zap (e.g. change channel) to watch a second program 120 currently being broadcast on channel 2. Zapping from channel 1 to channel 2 usually takes some time before the video content playing device is able to display the second program 120 currently being broadcast on channel 2.

In accordance with embodiments described herein, during the zapping time (i.e., between t1 and t2), the video content playing device is operative to collect enough data allowing it to make a judgment of the intent behind the viewer's rendezvous with channel 2. The video content playing device is further operative to process the collected data in view of channel 2's business context and content catalogue in order to identify and present to the viewer, at t2, a personalized alternate content 110 for a given period of time (corresponding to the time difference between t2 and t3 in FIG. 1).

After displaying the personalized alternate content 110 and the zapping sequence between channel 1 and channel 2 is complete, the second program 120 currently being broadcast on channel 2 may be presented (at t3 in FIG. 1). The viewer may not be necessarily aware that he/she is experiencing a different linear TV channel to other people, but he/she will be re-aligned to the standard linear schedule of channel 2 in a timely manner. Hence, by processing how the user reached a channel, TV operators and/or TV channel operators may make informed decisions that increase the likelihood of retaining viewership or increasing engagement.

The presented alternate content may be of any suitable form and may include any type of information associated with the channel the viewer has tuned to such as video, audio, graphics, pictures, text, and multimedia content. Examples of alternate content to be presented to a viewer include, but are not limited to, the following: advertisements, music or other audio information, icons representing particular services, current promotions, live streams, still images and program suggestions. Table 1 below gives some exemplary alternate contents that may be presented according to different zapping scenarios:

TABLE 1

| Scenario | | Possible personalized |
|---|---|---|
| The viewer tunes to | What the viewer would | alternate content that |
| Channel 2 . . . | see today | could be displayed |
| . . . into a show | End of the show | Present an advert instead |
| which is just ending | including its credits | so that the viewer gets an |
| and which he has no | sequence. | extended ad slot. |
| history of watching. | | |
| . . . into a live | Interstitial content that | Present some ambient |
| soccer game just | precedes the start of the | images from the soccer |
| before it is due to | soccer game. | stadium in order to build |
| start. | | excitement and |
| | | engagement. |
| . . . in half-way | The show at the point in | Present a promo for the |
| through a show he | time the viewer tuned to | episode in order not to |
| is also recording. | Channel 2. | reveal any important plot |
| | | developments. |
| . . . but is only | The fraction of a second | Present a quick attention |
| channel surfing past | of the show currently | grabbing frame in order |
| it to another | being broadcast on | to try and tempt the |
| channel. | Channel 2. | viewer to stop and watch |
| | | Channel 2. |
| . . . into a show he | The show the viewer has | Present a promo for the |
| has already | already watched. | next episode of the show. |
| watched. | | |

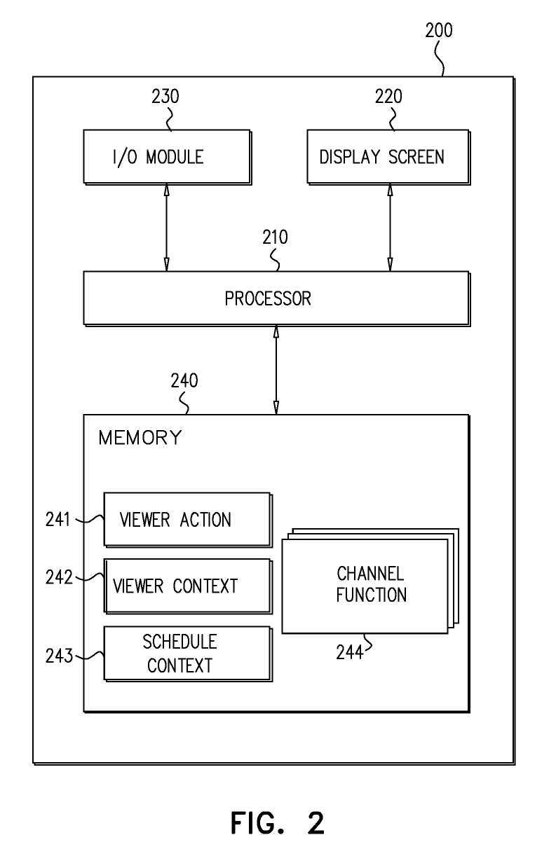

Reference is now made to FIG. 2 which is a schematic illustration of an exemplary video content playing device 200, operative to collect and process data relevant to a tuning context (i.e., a context in which a viewer tunes to a particular channel) to identify and present personalized alternate content. In accordance with an exemplary embodiment described herein, video content playing device 200 may be implemented as a set-top box device. However, it will be appreciated that video content playing device 200 may also be implemented using any suitable computing device, such as, for example, but not limited to, a personal computer, tablet computer, smartphone or laptop computer. Video content playing device 200 comprises processor 210, display screen 220, I/O module 230, and memory 240.

It will be appreciated that the depiction of display screen 220 and memory 240 as integrated components of video content playing device 200 may be exemplary. In some embodiments of the present invention, the functionalities of display screen 220 and memory 240 may be implemented as independent components accessed by video content playing device 200. For example, display screen 220 may be implemented as a television on which video content received via I/O module 230 is presented. Furthermore, in some embodiments of the present invention, some or all of the components of video content playing device 200 may be cloud based and accessible via a communications network such as, for example, a LAN (Local Area Network), WAN (Wide Area Network) or the Internet.

It will also be appreciated that video content playing device 200 comprises at least one non-transitory processor-readable storage media (e.g. memory 240). The memory 240 may store instructions, which the processor 210 may execute, in order to perform the methods described herein. Memory 240 may also store some or all of the alternate contents (not shown) that may be presented to the viewer as well as data to be used by the processor 210 to identify which alternate content to present. Memory 240 may comprise read only memory (ROM), random access memory (RAM), magnetic disk storage media devices, optical storage media devices, flash memory devices, electrical, optical, or other physical/tangible (e.g. non-transitory) memory storage devices. FIG. 2 depicts four blocks within memory 240 namely viewer action 241, viewer context 242, schedule context 243 and channel function 244 that will be described in further details hereinbelow. Although only one memory 240 is depicted on FIG. 2, those skilled in the art will appreciate that a plurality of memories (local or remote) may be provided and the elements 241-245 may be stored in a same or different memories of the plurality of memories.

Video content playing device 200 comprises hardware and software components, such as are well-known in the art. It will be appreciated that video content playing device 200 may comprise more than one processor 210. For example, one such processor 210 may be a special purpose processor operative to at least identify and present an alternate content on display screen 220 according to a method described herein. Processor 210 may be operative to execute instructions stored in a memory 240. I/O module 230 may be any suitable hardware and/or software component operative to use protocols such as are known in the art to receive and/or send video content and associated commands and/or instructions.

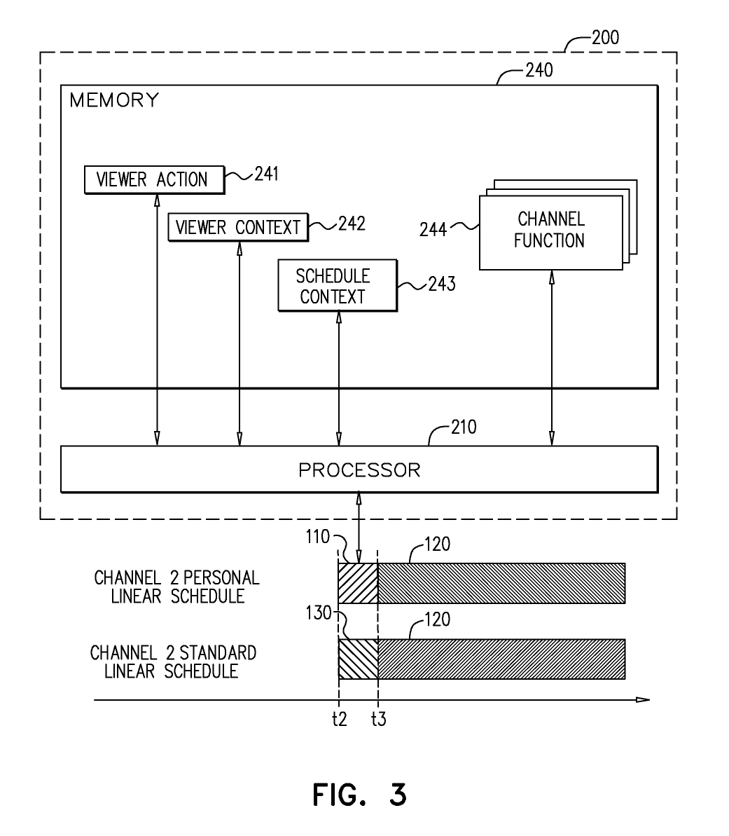

Reference is now made to FIG. 3 which is a partly pictorial, partly schematic illustration of elements of the video content playing device 200 of FIG. 2 operative to present alternate content when a viewer tunes to a particular channel. Although only memory 240 and processor 210 are depicted in FIG. 3, it will be apparent to those skilled in the art that the video content playing device 200 comprises the different elements described hereinabove in relation to FIG. 2.

The processor 210 may be operative to collect and store, in the viewer action element 241 of memory 240, data representative of the navigation pattern that preceded a channel change. In other words, this data describes how the viewer reached a particular channel. There are many ways for a viewer to reach a particular channel and different levels of intent may be inferred from each of them. The list below provides some non-limiting examples of data collected by the processor 210 and representative of different navigation patterns:

channel up/down buttons;

sequence of channel up/down buttons by viewer repetition;

sequence of channel up/down buttons by remote control auto-repeat;

direct channel change by typing a channel number;

selection of a channel from an EPG (Electronic Program Guide);

selection of a program from an EPG;

on-screen reminder (auto-tuning);

first channel after STB power on;

selection from companion device or application; etc.

Additional data may also accompany the specifics of the viewer action. For example, but not limited to, the video content playing device 200 may also monitor the channel the viewer came from before the channel change. This may provide, in some situations, additional information on the viewer's intent. For example, when the viewer is tuning to a channel which is a temporally displaced version of the previous channel, it may be inferred that the viewer's intent is to watch again or has missed a particular portion of a program. Another example of additional data may be the frequency with which the navigation has previously occurred. For example, the viewer may have been channel surfing up and down repeatedly over the last fifteen minutes or he/she may have done it only once during this time period.

Additionally, the processor 210 may be operative to collect and store, in the viewer context element 242 of memory 240, data relevant to the viewer and/or the household. The list below provides some non-limiting examples of such data:

demographics and geography;

presence of programs (or genre, subgenres, etc. of programs) in the DVR (Digital Video Recorder) planner;

viewing history;

recording history;

previous responses to linear TV changes made by the system; etc.

Furthermore, the processor 210 may be operative to collect and store, in the schedule context element 243 of memory 240, data representative of the program currently being broadcast on the channel reached by the viewer. The list below provides some non-limiting examples of such data:

current position within the program on the channel;

next program in schedule and when this next program starts;

current promotions relevant to the channel;

information about the program status such as whether it is a live event, a popular show, a first run show;

whether the current position in the program would contain spoilers, such as soccer scores, judge results; etc.

When the viewer tunes to a particular channel, the processor 210 may also be operative to retrieve: data relevant to the tuning context such as, for example, data from the viewer action element 241, the viewer context element 242 and the schedule context element 243 of memory 240; identify a channel function 244 associated with the particular channel; and execute the channel function 244 using the retrieved data. A channel function 244 is employed to increase the likelihood that a “zapping” or “surfing” viewer will stay tuned to the particular channel by processing tuning context data such as elements 241, 242 and 243, in order identifying alternate content that may attract the interest of the viewer.

By way of illustration, in accordance with an exemplary embodiment, data from the viewer action element 241 may indicate that the first channel after STB power-on was an all-sports channel, and that the viewer had been repeatedly changing channels by directly typing in the channel numbers for three other all-sports channels. Data from the viewer context element 242 may indicate that the most of the recordings are of college football games. Data from schedule context element 243 may indicate that a college football game is scheduled to start on the current channel in five minutes. Given such exemplary tuning context data from elements 241, 242 and 243, the channel function 244 may determine that alternate content related to college football, and particularly the game scheduled to begin in five minutes, may attract the interest of the viewer and encourage him/her to stay tuned to the channel until the football game starts. Accordingly, in accordance with the exemplary embodiment, the channel function 244 may be operative to return a n address for a suitable alternate content item, such as, for example, a five minute pre-game review of the scheduled game.

A channel function is typically a set of software instructions defined and controlled by a channel operator enabling the processor 210 to identify which alternate content to present when the viewer tunes to a particular channel. As such, each channel operator may provide at least one channel function that may be stored either locally in memory 240 of the video content playing device 200 or remotely (e.g. in the “cloud”, at a headend, etc.).

Accordingly, a channel function may be understood to be a logical construct which takes contextual input from the system in various classes and computes whether alternative content should be shown. In accordance with embodiments described herein, there may be several implementation options for a concrete instantiation of such a function. For example: a channel function may be implemented as a standard piece of software written in an imperative language such as Java and accessed directly in a runtime environment such as is known in the art. This option may provide maximal flexibility of the algorithms being used, but may also require significant resources in order to perform in the runtime environment. Alternatively, or in addition, the channel function may be implemented within the context of a ruleset within a rules engine. This may serve to normalize the runtime environment requirements, but conversely may also restrict the algorithms used to those that may be expressed as a set of connected rules. Alternatively, or in addition, a decision tree may be used to implement the channel function. A decision tree is a declarative document which may be computed in a single forward pass, thereby limiting its impact on the execution environment, but possibly precluding the use of overly complex decision algorithms in the function.

It will therefore be appreciated by one of ordinary skill in the art that the channel functions may be encoded in pre-defined meta-languages, declarative models or decision matrices, which contain their processing capabilities in some finite way or, alternatively, they may be freely coded in imperative languages by software engineers working for the channel providers. In any case, each channel function 244, when executed by the processor 210 using the data relevant to the tuning context, returns a network address, such as, for example, but not limited to, a URL (Uniform Resource Locator) locating the alternate content to present to the viewer or a NOP (No OPeration) command indicating that no alternate content is to be presented to the viewer.

If the processor 210 receives a URL as result of the channel function processing, the processor 210 is further operative to present the alternate content per the URL to the viewer on the display screen 220 at t2 before switching-back to the program currently being broadcast on the channel at t3. To do so, the processor 210 first retrieves the alternate content using the URL before frame-level switching-in the alternate content into the linear stream and frame-level switching-back to the linear stream once the alternate content has been presented to the viewer. Although Channel 2 may be ready to be presented before t3 (i.e. the zapping process may be achieved before t3), the alternate content is presented for a given period of time defined by the channel function 244 and corresponding to the time duration between t2 and t3 as depicted on FIG. 3. It will be appreciated that presenting the alternate content during the given period of time does not provoke any time displacement of the linear schedule of FIG. 2. In an exemplary embodiment of the present invention, real time, frame accurate video splicing techniques may be used by the video content playing device 200 to accurately insert the alternate content into a live linear stream. This situation is illustrated on FIG. 3 and depicted as the ‘Channel 2 personal linear schedule.’ The viewer has tuned to channel 2 and the video content playing device 200 presents the alternate content 110 to the viewer before switching back to the program 120 currently being broadcast on channel 2.

It will be appreciated by one of ordinary skill in the art that the insertion of personalized alternate content 110 introduces a temporary lack of synchronization between the content stream received by the exemplary viewer (as depicted as the ‘Channel 2 personal linear schedule’ and the content stream received by other viewers of “Channel 2” (i.e., “Channel 2 standard linear schedule”). Between t2 and t3, while the exemplary viewer receives alternate content 110, other viewers receive standard content 130. Accordingly, while the exemplary viewer may not receive standard content 130, the switch back video (120) is the same for both the exemplary viewer and other viewers. It will therefore be appreciated that after an initial, period of time (i.e., t2 and t3) where the content received by the exemplary viewer is not synchronized with the content received by the other viewers, eventually (i.e., from t3 forward) the content received by the exemplary is synchronized with Channel 2's standard linear schedule, i.e., the current broadcast stream from “Channel 2”.

If the processor receives a NOP command as result of the channel function processing, no further action is taken by the processor 210. As a result, standard content 130 is presented to the viewer, i.e., the program currently being broadcast on the channel the viewer has tuned to is presented on display screen 220, and alternate content 100 is not presented. Similarly, alternate content 110 is not presented to the viewer if the channel function 244 does not respond in a timely manner (e.g. before the end of the zapping process) or if the URL received by the processor 210 is inaccessible. This situation is illustrated on FIG. 3 and depicted as the ‘Channel 2 standard linear schedule.’ The viewer has tuned to channel 2 and the video content playing device 200 presents the program 120 currently being broadcast on channel 2 once the zapping process is complete.

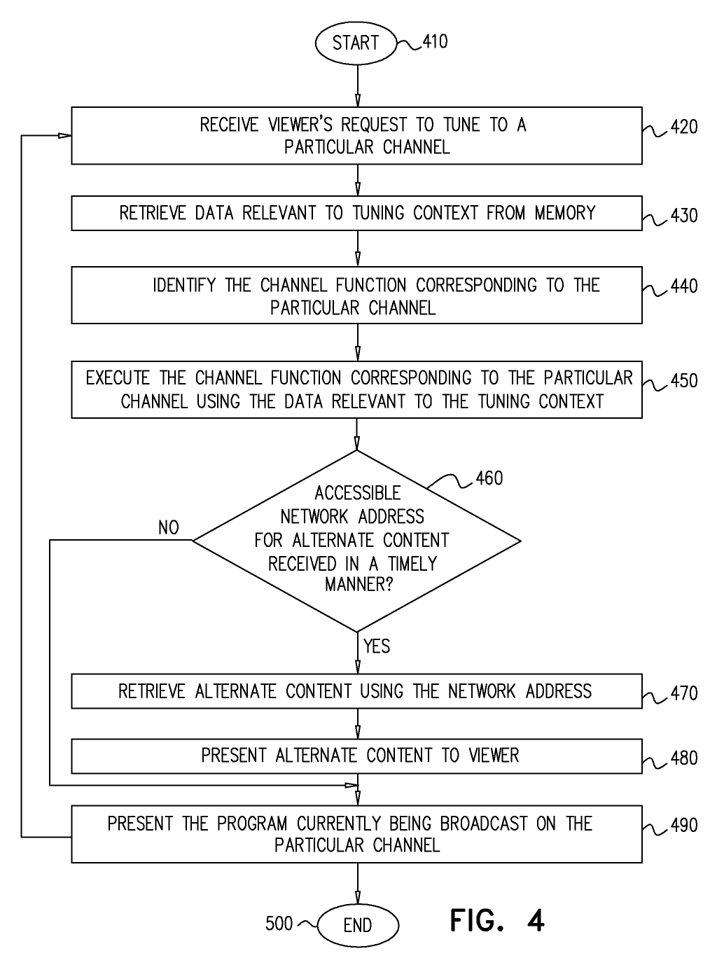

Reference is now made to FIG. 4 which illustrates a method 400 for identifying and presenting the alternate content 110 of FIG. 1 in accordance with embodiments described herein. The process 400 starts at step 410 and continues at step 420 at which the video content playing device 200 may receive a viewer's request to tune to a particular channel. The viewer may use any suitable method or mechanism to input the request and/or other inputs to be processed by process 400. For example, a set-top box remote control may be used. In such a case, one or more of the buttons on the remote control may be programmed to send the request. It will be appreciated that video content playing device 200 may be configured to receive input from other input devices such as, for example, a companion device, a mouse, a pointing device, a keyboard or voice commands.

In response to such a request, processor 210 of video content playing device 200 may retrieve (step 430) data relevant to the tuning context from the viewer action element 241, the viewer context element 242, and the schedule context element 243 of memory 240 (step 430). video content playing device 200 may then identify a channel function 244 corresponding to the particular channel the viewer has tuned to (step 440).

Subsequently, processor 210 of video content playing device 200 may execute the identified channel function 244 using the data relevant to the tuning context described hereinabove (step 450). In other words, the data relevant to the tuning context are retrieved from the viewer action element 241, the viewer context element 242, and the schedule context element 243. This data may then be usable by the processor 210 as input to the channel function 244.

Combining relevant data from these three elements allows the channel function 244 to return an alternate content which is the most in line with the viewer's intent. However, it will be appreciated that, in some deployed systems, it may not be possible to collect and/or retrieve the three classes of data. Therefore, in some embodiments described herein, at least one class of data may be retrieved and used by the channel function 244.

If, according to the result of step 450, the processor 210 receives a network address locating an alternate content in a timely manner (step 460), the processer 210 retrieves (step 470) the alternate content using the network address. Otherwise, the process 400 may proceed to step 490. In some embodiments described herein, alternate contents that may be presented to viewers are prepared in advance and gathered as a catalogue of available alternate contents. Additionally and/or alternatively, alternate contents available to be presented to viewers may be placed in advance at a particular network location or at different network location(s) which is/are accessible in a timely manner, thereby speeding up the retrieval process.

Once retrieved, the processor 210 frame-level switches-in the alternate content within the linear stream and the alternate content is presented to the viewer (step 480). Then, at step 490, the processor 210 frame-level switches-back to the linear stream at the end of the alternate content and the program currently being broadcast on the particular channel is presented. Once the presentation is thusly synchronized with the current program being broadcast, the Process 400 may then end (step 500).

Alternatively, or in addition, the switch back to the linear stream may be done at any suitable time rather than specifically at the end of the alternate content. For example, but not limited to, the switch back may be done at a set time or after a set duration defined by the channel function 244. This may be useful in situations where the alternate content is a live stream (e.g. ambient images from the soccer stadium before a soccer game) with no predefined end or duration. In such a case, the channel function 244 returns to the processor 210 a set time or duration at which the linear stream of the particular channel is to be presented.

In accordance with embodiments described herein, in addition to a URL for alternative content, the channel function 244 may also return an additional piece of metadata. This metadata may indicate how much of the alternative content to show before proceeding to step 490. Where the alternative content is short, for example a 30 second ad, there may be an indication to show the alternative content in its entirety before switching back to the linear stream. In accordance with embodiments described herein, this may be the default behavior for alternative content signaled by channel functions 244.

However, there may be cases where the alternative content is long, never-ending or of indeterminate length. The ambient view of a sports stadium prior to the broadcast of a sports event may be an example of such a case. In such a case, it may not be relevant to wait until the “end of the alternate content” before switching back to the normal linear stream. In such a case, the channel function 244 must therefore indicate the switch back point in the metadata it returns.

The switch back point is therefore a temporal reference which may be either relative to the alternative content, or absolute, based on “wall clock” time. For example, the channel function 244 may indicate that the switch back should occur after 60 seconds of alternative content has been played out. Alternatively it may indicate that the alternative content should continue until 20:00:00 by wall clock time.

Another, more advanced, option may be to initiate switching back based upon a particular broadcast signal. For example, a particular channel may be presenting a series of interstitial announcements prior to the start of a new program. In such a case, the alternate content may be provide in order to increase the likelihood that a “zapping” or “surfing” viewer will stay tuned to the particular channel at least until the new program starts. Accordingly, the channel function 244 may indicate that the presentation of alternative content should continue until the new program has begun its broadcast based upon standard broadcast signaling triggers.

If the processor 210 receives a NOP command, does not receive a response from the channel function 244, or if the URL received is not accessible, no further action is taken and the program currently being broadcast on the particular channel is presented to the viewer once the zapping process is complete (step 490).

It will be appreciated that the video content playing device 200 may receive a further viewer's request to tune to another channel at any time during the process 400. In such a situation, the process 400 returns to step 420.

The process ends at step 500.

It will be appreciated by one of ordinary skill in the art that in accordance with embodiments described herein, the process 400 may be implemented with an optional step allowing users to have an “override” capability in case the alternate content is undesirable to the viewing user. Similarly, in accordance with embodiments described herein, video content playing device 200 may be configured with a user interface (UI) function to enable a viewing user to enter settings to limit to some extent the frequency and/or duration of alternate content presentation. The information entered via this UI function may be included in the tuning context data processed by channel function 244.

It is appreciated that software components of the present invention may, if desired, be implemented in ROM (read only memory) form. The software components may, generally, be implemented in hardware, if desired, using conventional techniques. It is further appreciated that the software components may be instantiated, for example: as a computer program product or on a tangible medium. In some cases, it may be possible to instantiate the software components as a signal interpretable by an appropriate computer, although such an instantiation may be excluded in certain embodiments of the present invention.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined by the appended claims and equivalents thereof:

1. A method for presenting alternate content during a channel change on a video content playing device, said method comprising:
receiving a viewer's request to tune to a particular channel;
retrieving tuning context data from a memory of said video content playing device, wherein said tuning context data is indicative of a context in which said viewer tunes to said particular channel and comprises:
channel navigation data representive of a navigation pattern for tuning to said particular channel,
viewer action data representative of at least one navigation action performed to input said viewer's request, and
schedule context data representative of a program currently being broadcast on said particular channel;
processing said tuning context data using a channel function associated with said particular channel to identify alternate content likely to be of interest to a viewer of said particular channel;
identifying a network address for said alternate content associated with said particular channel in accordance with a result of said processing;
retrieving said alternate content according to said network address; and
presenting said alternate content on said video content playing device before presenting a program currently being broadcast on said particular channel.

2. The method of claim 1, further comprising:
providing duration metadata with said result of said processing, wherein said duration metadata indicates a duration for said presenting said alternate content.

3. The method of claim 1, wherein said alternate content is presented for a given period of time before said presenting said program currently being broadcast on said particular channel.

4. The method of claim 3, wherein said alternate content has a predefined duration and said given period of time corresponds to said predefined duration.

5. The method of claim 3, wherein said alternate content has no predefined duration and said given period of time is defined by said channel function.

6. The method of claim 3, where said presenting said alternate content continues until a particular broadcast signal is received from said particular channel.

7. The method of claim 1, wherein said presenting said alternate content comprises splicing said alternate content into the linear stream of said particular channel.

8. The method of claim 1, further comprising:
gathering alternate contents to form a catalog of alternate contents available to be presented to viewers;
storing said catalog in a network location; and
wherein said retrieving step comprises retrieving said alternate content using a uniform resource location (URL) received as a result of said processing by said channel function, said URL locating said alternate content associated with said particular channel within said catalog.

9-10. (canceled)

11. The method of claim 1, wherein said processing comprises directly accessing said channel function in a runtime environment, wherein said channel function is implemented as a standard piece of software written in an imperative language.

12. The method of claim 1, wherein said channel function is implemented as a set of rules processed by a rules engine.

13. The method of claim 1, wherein said channel function is implemented as a decision tree.

14. The method of claim 1, wherein said channel function is employed to increase the likelihood that said viewer will stay tuned to said particular channel.

15. The method of claim 1, further comprising:
if no alternate content is identified by said processing, returning a NOP (No OPeration) command indicating that no alternate content is to be presented to the viewer; and
presenting said program currently being broadcast on said particular channel.

16. A video content playing device comprising:
an I/O module;
a display screen;
a memory; and
a processor, said processor being operative to execute instructions in said memory to:
receive a viewer's request to tune to a particular channel,
retrieve tuning context data from said memory of said video content playing device, wherein said tuning context data is indicative of a context in which said viewer tunes to said particular channel and comprises:
channel navigation data representative of a navigation pattern for tuning to said particular channel,
viewer action data representative of at least one navigation action performed to input said viewer's request, and
scheduled context data representative of program currently being broadcast on said particular channel,
process said tuning context data using a channel function associated with said particular channel to identify alternate content likely to be of interest to a viewer of said particular channel,
identify a network address for said alternate content associated with said particular channel in accordance with a result of said processing,
retrieve said alternate content via said I/O module according to said network address, and
present said alternate content on said display screen before presenting a program currently being broadcast on said particular channel.

17-18. (canceled)

19. The video content playing device of claim 16 wherein said channel function is implemented as either a set of rules processed by a rules engine, or as a decision tree.

20. (canceled)

21. The method according to claim 1 and where at least one said navigation action is at least one of:
a sequence of channel up/down buttons by viewer repetition;
a sequence of channel up/down buttons by remote control auto-repeat;
a first channel after STB power on; or
a selection from a companion device or application.

22. The method according to claim 1 and wherein said schedule context data represents at least one of:
a current position within said program on said particular channel;
a next program in a channel schedule and when said next program starts;
current promotions relevant to said particular channel;
program status information about whether said program is a live event, a popular show, or a first run show; or
whether said current position contains spoilers.

23. The method according to claim 16 and where said at least one navigation action is at least one of:
a sequence of channel up/down buttons by viewer repetition;
a sequence of channel up/down buttons by remote control auto-repeat;
a first channel after STB power on; or
a selection from a companion device or application.

24. The method according to claim 16 and wherein said schedule context data represents at least one of:
a current position within said program on said particular channel;
a next program in a channel schedule and when said next program starts;
current promotions relevant to said particular channel;
program status information about whether said program is a live event, a popular show, or a first run show; or
whether said current position contains spoilers.
